(19) United States
(12) Patent Application Publication
(10) Pub. No.: US 2006/0234790 A1
(43) Pub. Date: Oct. 19, 2006

(54) Discharge elbow for a forage harvester

(76) Inventor: Georg Kormann, Zweibrucken (DE)

Correspondence Address: DEERE & COMPANY, ONE JOHN DEERE PLACE, MOLINE, IL, 61265, US

(21) Appl. No.: 11/401,676

(22) Filed: Apr. 11, 2006

(30) Foreign Application Priority Data
Apr. 14, 2005 (DE) 10 2005 017 121.4

(51) Int. Cl. A01F 12/60

(52) U.S. Cl. 460/119

(57) ABSTRACT

A discharge elbow for a forage harvester. The discharge elbow includes an outer wall and two side walls that extend away from the outer wall. Together, the walls form a guidance for the flow of harvested crop ejected by the forage harvester. The discharge elbow includes an optical sensor for determining the material contents of the harvested crop. The sensor interacts with the harvested crop through an opening in the outer wall. The side walls converge towards the outer wall over at least the partial length of the discharge elbow adjoining the opening. The flow of crop is thus concentrated so that the material content of the harvested crop can be determined even at low throughput values.

### BACKGROUND

1. Field of the Invention

The present invention generally relates to a discharge elbow for a forage harvester.

2. Description of Related Art

Forage harvesters are used in agriculture in order to cut crop from a field, to pick up the crop, or to chop the crop by means of a chopper drum or a disk wheel chopper and, after accelerating it by means of a blower, to discharge it to a transport vehicle through an adjustable discharge elbow. In most cases the harvested plants are used in the form of silage as fodder for animals.

For reasons of manufacture and cost, the discharge elbow is typically provided with a rectangular cross section and consists of steel. In the case of smaller attached choppers and stationary hay conveyors, round cross sections are also applied to the discharge elbow.

In the case of low throughput discharge elbows with rectangular cross sections, a scattered ejection pattern can be observed. A measuring arrangement may be provided for the determination of the material contents, for example water, that operates optically in the near infrared region. While the measuring arrangement can be attached to a discharge elbow with a rectangular cross section, at least in the case of low throughput, the rectangular discharge elbow results in a material flow distribution unfavorable to the measuring arrangement. At present, a high flow of harvested crop is required at this location for the determination of the material contents by means of an infra-red measurement technique, since the harvested crop is at all times distributed over the entire width of the discharge elbow. A further disadvantage of the discharge elbow with rectangular cross section lies in the fact that relatively high loads are applied to the side walls, so that the discharge elbow must be configured relatively massively and is therefore quite costly.

### SUMMARY

In satisfying the above need, as well as overcoming the enumerated drawbacks and other limitations of the related art, the present invention provides an improved discharge elbow for a forage harvester that permits the determination of the material contents in the harvested crop by means of an optical measurement arrangement.

A discharge elbow is provided with a radial outer wall and two side walls closely connected to the outer wall. The discharge elbow is located relative to the path of the harvested crop ejected by the forage harvester, and the harvested crop is conducted between the two side walls of the discharge elbow. In the embodiments, at least a portion of the side walls converge towards the outer wall, at least in a region of the discharge elbow adjoining an opening for an optical measurement arrangement. Accordingly, the cross section or the width of the discharge elbow tapers towards the outer wall. Further, the side walls can merge directly into each other so that the outer wall has a width that almost disappears at the merge.

In this way, the result is that the harvested crop is concentrated in the vicinity of the outer wall. As a result, the measurement arrangement can determine material contents and/or other properties of the harvested crop at that location, even at a low throughput of the harvested crop. By concentrating the harvested crop in the vicinity of the outer wall, a converging discharge pattern is generated.

The discharge elbow may have various side wall shapes. In one possible embodiment, the side walls and the outer wall extend in the shape of a parabola. In another configuration, first sections of the side walls are spaced away from the outer wall and extend at right angles to the outer wall, while second sections of the side walls extend at an angle to the outer wall and connect the outer wall with the first sections of the side walls extending at right angles to the outer wall. Any desired round section and/or struts can also be combined with each other.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 shows a forage harvester with a discharge elbow;

FIG. 2 shows a perspective view of a section through a discharge elbow according to a first embodiment of the invention;

FIG. 3 shows a perspective view of a section through a discharge elbow according to a second embodiment of the invention; and

FIG. 4 shows a perspective view of a section through a discharge elbow according to a third embodiment of the invention.

### DETAILED DESCRIPTION

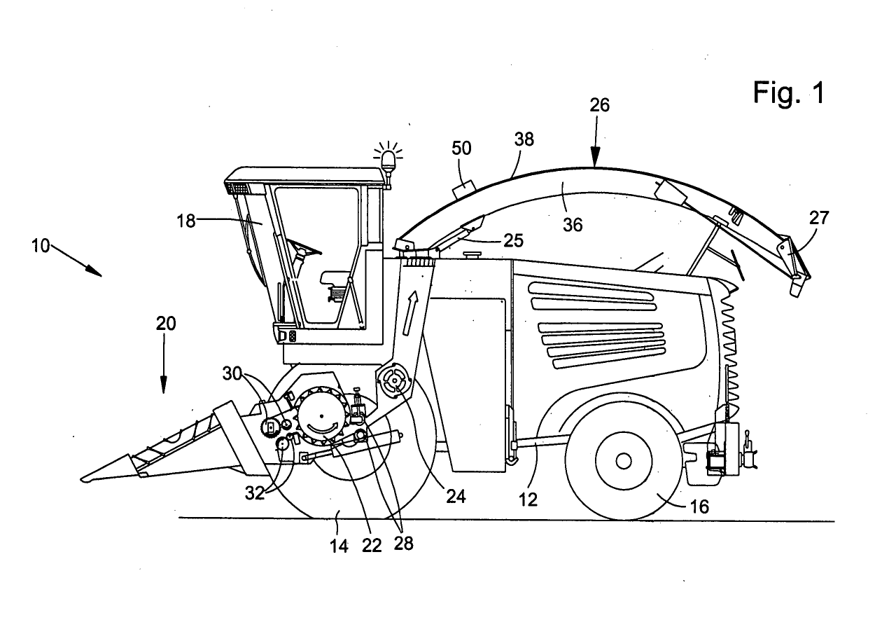

A self-propelled forage harvester 10, shown in FIG. 1, is supported on a frame 12 that is carried by driven front wheels 14 and steerable rear wheels 16. The forage harvester 10 is controlled from an operator's cab 18 from which a front harvesting attachment 20, appropriate for the harvest of stalk-like plants, can be visually seen and controlled. As illustrated, the front harvesting attachment 20 is a corn head that operates independent of rows. Crop taken up from the ground by means of the harvesting attachment 20, for example, corn, cereal crop or the like, is conducted through upper rough pressing rolls 30 and lower rough pressing rolls 32 to a chopper drum 22 that chops the crop into small pieces and delivers it to a conveyor arrangement 24. A post chopper reduction arrangement 28 extends between the chopper drum 22 and the conveyor arrangement 24, through which the crop to be conveyed is conducted tangentially to the conveyor arrangement 24. The harvested crop leaves the forage harvester 10 to an accompanying trailer through a discharge elbow 26.

At its upstream end the discharge elbow 26 can be rotated about the vertical axis by a first actuator. A second actuator 25 permits an adjustment in height of the discharge end of the discharge elbow 26 and a third actuator makes it possible to pivot a discharge flap 27.

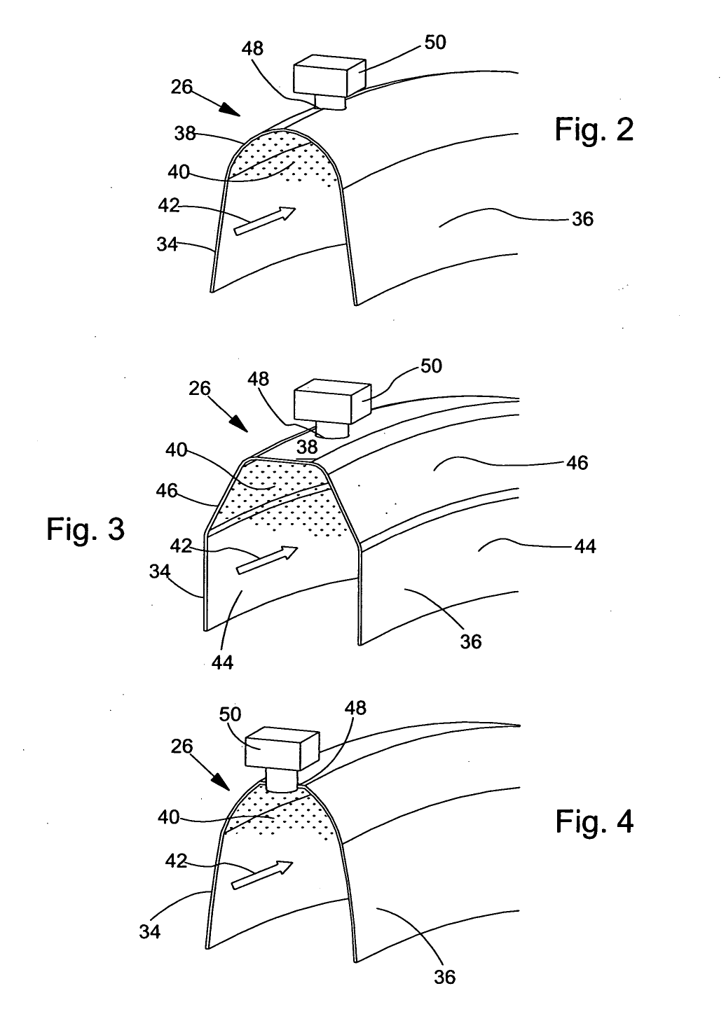

FIG. 2 shows a cross section of a first embodiment of a discharge elbow 26. The discharge elbow 26 is formed in the shape of an inverted gutter and includes side walls 34, 36 that are connected to each other by a disappearingly minute outer wall 38. The walls 34 through 38 are arranged in a parabolic shape and are open downward, although stabilizing elements or a continuous floor (not shown) extending transverse to the lower ends of the side walls 34, 36.

FIG. 3 shows a second embodiment of a discharge elbow 26, where elements coinciding with the first embodiment are identified by the element numbers. In the embodiment according to FIG. 3, the outer wall 38 is flat in itself and extends transverse to the direction of flow 42. Each of the side walls 34, 36 includes a lower section 44, that extends generally orthogonally to the outer wall 38, and an upper section 46 that extends at an angle to the lower section 44 and the outer wall 38, so that the upper section 46, in effect forms a skewed corner.

FIG. 4 shows a third embodiment of a discharge elbow 26, in which elements coinciding with the first embodiment are indicated by the same element numbers. In the embodiment according to FIG. 4, the outer wall 38 is flat in itself in a direction transverse to the direction of flow 42. The side walls 34, 36 form a smooth transition in a bow shape to the outer wall 38.

In each of the embodiments, an opening 48 is provided in the outer wall 38 for a measurement arrangement 50 to be used in determination of the material contents and/or the other properties of the harvested crop 40. An appropriate measurement arrangement is disclosed in U.S. Pat. No. 6,421,990, the contents of which are herein incorporated by reference.

All three embodiments have in common the fact that the harvested crop 40 flowing in the direction of flow 42 ejected by the conveyor arrangement 24 moves along a bow-shaped curved path (see FIG. 1) during its passage through the discharge elbow 26. As a result, the harvested crop 40 is concentrated in the vicinity of the outer wall 38 on the basis of centrifugal force. Due to the converging of the side walls 34, 36 toward the outer wall 38 of the discharge elbow 26, the width of the flow of harvested crop 40 remains relatively small in the vicinity of the outer wall 38. Thereby, the result is a centered ejection of the harvested crop 40 at the discharge end of the discharge elbow 26 and a useful measurement result at the measurement arrangement 50, even with relatively low throughput of harvested crop. The measurement arrangement 50 interacts with the harvested crop 40 through the opening 48 in the outer wall 38 of the discharge elbow 26. A wear resistant window of diamond or sapphire glass may be located in the opening 48.

Because of the present configuration, the discharge elbow 26 is provided with a higher strength than the previous rectangular configurations. As a result, discharge elbow may be manufactured of plastic in an injection molding or an extrusion process.

The cross sections shown in FIGS. 2 through 4 may extend over the entire length of the discharge elbow 26. Alternatively, these cross sections may be provided over the partial sections thereof, in the vicinity of the measurement arrangement 50.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I/We claim:

1. A discharge elbow for a forage harvester comprising:
an outer wall and two side walls extending away from the outer wall, the two side walls with the outer wall form a border for a flow of harvested crop ejected by the forage harvester;
an optical measurement arrangement for determining material contents of the harvested crop, the optical measurement arrangement interacting with the harvested crop through an opening in the outer wall;
wherein at least a portion of the side walls converge towards the outer wall in a region of the length of the discharge elbow adjoining the opening.

2. The discharge elbow of claim 1, wherein the outer wall and the two side walls are configured to direct the harvested crop across the opening.

3. The discharge elbow of claim 1, wherein the outer wall and the two side walls form a parabolic cross section.

4. The discharge elbow of claim 1, wherein the two side walls include a first section that is oriented at a right angle to the outer wall.

5. The discharge elbow of claim 4, wherein the first section spaced apart from the outer wall transverse to the direction of the flow of harvested crop.

6. The discharge elbow of claim 4, wherein the two side walls include a second section at an angle to the first section and the outer wall.

7. The discharge elbow of claim 6, wherein the second section is attached to and extends between the first section and the outer wall.

8. The discharge elbow of claim 1, wherein the width of the outer wall transverse to the direction of the flow of harvested crop is reduced at least in the partial region of the length of the discharge elbow adjoining the opening.

9. The discharge elbow of claim 1, wherein the width becomes increasingly reduced along the flow of harvested crop.
